(19) United States
(12) Patent Application Publication
(10) Pub. No.: US 2008/0260596 A1
(43) Pub. Date: Oct. 23, 2008

(54) Fluidizing Base, Method for the Production Thereof and Associated Fluidizing Device

(75) Inventor: Antonius Johannes Maria Bouman, Drachien (NL)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Tetra Lval Holdings & Finance SA

(21) Appl. No.: 11/793,775

(22) PCT Filed: Dec. 22, 2005
(86) PCT No.: PCT/NL05/00883

§ 371 Date: Mar. 17, 2008

(30) Foreign Application Priority Data
Dec. 22, 2004 (NL) 1027844
May 10, 2005 (NL) 1028999

(51) Int. Cl. B01J 8/44; F26B 3/08; B23K 26/38; B23K 15/08

(52) U.S. Cl. 422/143; 219/121.18; 219/121.67; 219/122; 34/586

(57) ABSTRACT

The invention relates to a fluidizing base comprising a flat sheet (1) with holes (2) produced using a laser or electron beam. A sheet of this type has good fluidizing properties and also good cleanability.

The invention also provides a method for producing a fluidizing base of this type and a fluidizing device comprising a fluidizing base of this type.

The present invention relates in general to a fluidizing base, a method for the production thereof and an associated fluidizing device.

Many drying processes use an apparatus known as a fluid bed in which particulate product is treated by a flow of gas. A flow of, usually ascending, gas, for example hot air, flows through the product which is situated on a horizontal, gas-permeable sheet, also referred to as the fluidizing base, in the form of a layer. The speed of this flow of gas is such that the particles are in each case entrained for a short time, and in fact are more or less floating. This is also referred to as fluidization.

One of the functions of the fluidizing base, also referred to as a screening base, is to allow the gas to flow through the particulate layer in an even manner. Originally, the screening base was made up of a sheet into which holes had been punched by mechanical means, and which, due to the partially upright surrounding walls, closely resembled a grater. This sheet, also known as Conidur, was, and still is, produced by pressing bumps into a metal sheet using a kind of roller. Subsequently, cracks are formed in the bumps by local overstretching, which cracks form the air holes.

One of the drawbacks of such a sheet is that it is difficult to clean. The upright walls cause the product to become caught on the sheet or adhere to the sheet in another way, while any cleaning liquid which may be used cannot readily flow over the sheet either. Such problems may also occur if the sheet is turned over for use in a fluidizing base, as product particles or cleaning liquid may remain in the lower-lying indentations around the holes. In addition, there is a problem regarding the formation of cracks and tears in the material, as the latter is overstretched locally during the mechanical deformation. Obviously, such cracks, burrs and the like also result in reduced cleanability. Organizations, such as USDA or EHEDG, usually impose stringent requirements on hygiene, which are preferably to be met in order to be allowed to produce or deliver the respective products.

Another problem relates to powder falling through the sheet. The bumps of the sheet moving to and fro take “bites” out of the powder layer, and thus convey some of the powder to the other side of the sheet. This is problematic, in particular during start-up (and stopping), since all the fluidizing gas then only flows through the free holes, and it is then even easier to take bites out of the powder at the covered holes.

U.S. Pat. No. 5,839,207 discloses a fluidizing base comprising a sheet with bumps or dents, in which the bumps or dents are provided with gas flow holes which are at right angles to the sheet surface by means of punching or laser-cutting. Although attention has been given to the abovementioned problem, the cleanability is not ideal in this case either, in particular due to the presence of said bumps or dents. After all, when the latter are being produced, the material is deformed, which leads to a risk of cracks and fissures forming in said material. Moreover, the production is complicated since it involves a two-stage process of processing the sheet and making holes. If the gas flow holes are produced before the sheet is deformed, this will not only result in a risk of the holes splitting, but this will also make it impossible to accurately control the direction of the holes. If the holes are produced after the sheet has been deformed, a very complicated method is required in order to align the cutting apparatus with the bumps or the like, and, in addition, the angle at which work has to be carried out is disadvantageous: the publication mentions working from the bump downwards, towards the sheet, at an angle of 15°.

US patent application 2003/0070318 discloses a fluidizing base comprising a flat sheet having a series of radially arranged slots in it, which slots have been produced, for example, by laser-cutting. This fluidizing base is relatively easy to clean per se, but does not provide sufficient control regarding the fluid outflow direction. Partly for this reason, it can only produce in a batch process. This is of course undesirable with a view to continuous production methods.

It is an object of the present invention to provide a fluidizing base having good cleanability and a good and flexible control of the fluid outflow direction, and which can be produced relatively easily.

This object is achieved by the invention by a fluidizing base according to claim 1.

The dependent claims describe preferred embodiments which should not, however, be regarded as limiting.

The invention also relates to a method for producing a fluidizing base of this type, according to claim 16.

Producing the holes using a laser or electron beam inter alia offers the following advantages.

The sheet is only subjected to a small mechanical load, or not at all, and therefore remains very smooth and even. In this case, smooth and even is understood to mean that the top and bottom surface of the sheet are substantially plane-parallel and that the sheet is thus essentially free from dents. In this way, the sheet can be cleaned very easily.

The inner walls of the holes produced are of an excellent quality, which has a positive effect on the gas flow as well as the cleanability. If desired, this quality can be improved further by means of electropolishing or the like.

The quality of the walls and edges of the holes is very good, so that there are few, if any, problems regarding the cleaning away of residual product particles or the like.

The holes according to the invention have a cross section with a maximum length-to-width ratio of 2:1. This means that the ratio of the largest cross-sectional dimension is not more than twice as large as the smallest cross-sectional dimension. Preferably, this ratio is essentially 1:1, and preferably the holes have a round cross section. It should be noted that such holes, compared to slots, result in a much better control of the fluid flow direction. The fluid is controlled in two instead of only in one direction, thus preventing an uncontrolled outflow in the direction parallel to the length of the slot. In addition, when slots are used, it is not possible to modify the outflow direction very locally in two dimensions. After all, the slot itself already extends in two dimensions. By contrast, when holes are used, the fluid outflow direction may differ from hole to hole, i.e. may differ very locally. Such a locally different outflow direction can not be achieved using mechanical means, or only in a very laborious manner, whereas it is relatively easy to achieve using laser-cutting or electron beam cutting.

A preferred embodiment provides a fluidizing base in which a plurality of first holes are at a first angle to the sheet surface, a plurality of second holes are at a second angle to the sheet surface, and in which the first and second holes between themselves enclose an angle of more than 0°. In an advantageous embodiment, the first holes are arranged in a first group having a substantially parallel first outflow direction, and the second holes in a second group having a substantially parallel second outflow direction, different from the first outflow direction. In this manner, as a result of the various directions, a flexible way of conveying the particles over the fluidizing base, or for example an improved way of mixing the particles is created.

Advantageously, the first and second group each form a continuous, non-overlapping group. This means that one outflow direction is defined for each group. This offers good control of the outflow direction and thus the conveying direction of particles over the base.

An embodiment is also provided, in which the holes of the first and the holes of the second group alternate in a regular pattern. This can also be seen as providing a large number of, in each case inherently small, groups of holes. Obviously, one advantage is the optimum control of the outflow and thus conveying direction.

The pattern is in particular formed by strips which extend in the width direction of the fluidizing base and have, viewed in the longitudinal direction of the fluidizing base, a width of in each case not more than ten holes, advantageously not more than five holes. This is the case, in particular, with a substantially rectangular fluidized bed or part thereof. The pattern of alternating, per se narrow strips with holes, results in very good mixing of the particles, since mixing mainly occurs at the borders of the areas, and many borders can be defined in this way. In principle, the following applies: the narrower the strips, the more mixing can take place. However, a row with a width of 1 hole is not always particularly effective in defining and controlling the outflow direction. However, in most cases, this can be realized quite well if the number is five holes.

In general, the pattern preferably comprises parallel rows of holes, each hole being surrounded in a regular manner by four or six holes. This creates a regular pattern which ensures a very homogeneous fluidization. Of course, this surrounding arrangement relates in particular to holes with the same outflow direction, but sometimes it is advantageous to provide all holes in a regular pattern, irrespective of the outflow direction, since then, for example, the mechanical properties such as strength of the sheet are maintained as much as possible.

In one embodiment, the sheet comprises a central region with holes in a first direction, with several peripheral regions around it with holes having a respective direction such that product landing on it is conveyed to an end point situated on one of the peripheral regions.

Such an embodiment provides a fluidizing base for continuous use, as product can be supplied to the central region which, after some time, transfers the product to one of the edge regions, where it is slowly conveyed further via the other peripheral regions to the peripheral region which defines an outflow or conveying direction away from the fluidized bed, for example to a product discharge. Such a substantially round fluidizing base is sometimes used in what are known as well-mixed beds, having a quick mixing and quick drying action.

It should be noted that the abovementioned elongate fluidizing bases obviously also enable continuous operation and in many cases form part of plug-flow beds, having a well-defined residence time and drying action.

In principle, it is possible to provide continuous operation if it is possible to define a total outflow direction from a starting point (e.g. product supply) to an end point (e.g. product discharge). Precisely because the fluidizing base according to the invention, as well as the method to be described below, can provide the holes with various directions very easily, a very flexible design of the fluidizing base is possible.

Another advantage of making holes using a laser or electron beam is that it is possible to make the ratio of the diameter of the hole and the thickness of the sheet smaller than with mechanical methods, while using approximately similarly shaped holes. The latter methods require a ratio of diameter to sheet thickness of at least 1:1, while a ratio of less than 1:1 can advantageously be achieved easily using laser and electron beam cutting, for example a ratio of between 0.1:1 and 0.5:1.

Holes of the desired diameter, preferably between 0.2 and 0.8 to 1.0 mm, with a sheet thickness of, for example, 1-2 mm can be produced in a very expedient manner. Using known laser and electron beam techniques, a beam with a diameter of approximately 0.2 mm can easily be produced. This can be used to burn holes with a diameter of at least 0.2 mm. Such small holes and such small hole diameter/sheet thickness ratios are advantageous when producing a fluidizing base for, for example, processing fine particles, powders and the like. Generally with such light particles, a low fluid velocity is desirable. In order then still to achieve a homogeneous distribution thereof, many holes are required, which have to be small, though, partly in order to achieve the desired low numbers of small particles falling through. For example, for powders with particle diameters of, for example, 0.05-0.5 mm and a desired air speed of 0.1-1.2 m/s, an air permeability, i.e. a (total surface area of the holes):(sheet surface area) ratio is from 0.2-5%. Of course, these values are not intended to be limiting.

By choosing more powerful laser systems and/or increasing the width of the laser beam to for example 0.7 mm, the holes, up to approximately 0.8 to 1.0 mm, can still be burnt with one pulse, or with a few pulses at most, as the sheet material, preferably a metal, and advantageously stainless steel or another alloy which is able to withstand alkali and other cleaning agents, heats up and evaporates in such a manner that the hole is wider than the diameter of the laser beam. Precisely because the laser beam can operate in one spot in a pulsed mode and does not have to cut, the holes can be produced in a quick and efficient manner. As a non-limiting indication: using the method described, it is easily possible to produce up to approximately five holes per second, while with a method in which the laser beam cuts and thus moves over the circumference of the hole to be cut, at most one hole per five seconds can be produced using an identical laser system, all this depending on the diameter and length of the hole. Using an electron beam, even up to a few hundred holes per second can be produced.

The invention also relates to a fluidizing device having a fluidizing base according to the invention. Such a fluidizing device offers the advantage that it does not have to be cleaned as often and/or as thoroughly, so that the production efficiency increases. Moreover, during production, the purity and quality of the treated products is better than according to the prior art, as less material remains behind. Thus, any reduction in the quality of a product cannot be due to material remaining behind.

An important problem which is reduced by the invention is the problem of possible growth of bacteria, and of contamination of the product as a result of product remaining behind, moisture and heat. As the sheet and the device according to the invention can be cleaned more readily, there is less danger of product remaining behind on and in the sheet, and thus of the growth of bacteria and contamination.

The fluid bed is a process facility in which a pulverulent product is kept in a floating state on account of a vertical flow of air. In this state, the product can undergo a treatment. This treatment generally consists of drying in hot air, cooling in cool air or lecithinization. Other treatments are possible, such as for example agglomeration, granulation, coating, stripping, chemical reaction, etc.

Preferably, the fluidizing device comprises several areas with different gas outflow directions. Thus, the product can, for example, be readily mixed, or conveyed to the various areas and so forth.

In one special embodiment, the fluidizing base comprises a first, substantially round area having at least gas outflow directions in essentially the circumferential direction, as well as an adjoining elongate area having a net gas outflow direction in the longitudinal direction of this elongate area. Such a device thus has, for example, a substantially round well-mixed area with the associated quick mixing and drying action but less well-defined residence time, as well as an adjoining elongate plug-flow area with a well-defined residence time and drying result.

In particular, the elongate area comprises several partial regions having a gas outflow direction which is at an angle not equal to zero to the net gas outflow direction. In other words, the gas outflow direction varies from partial region to partial region, for the purpose of mixing, drying result, etc. The angle may be small relative to the net gas outflow direction, which incidentally often runs parallel to the longitudinal direction of the elongate area. This is the case, for example, when the residence time is to be short, such as for sensitive products. On the other hand, the angle can also be large, such as for example about or even larger than 90°, for longer residence times and very intense mixing. It should be noted that an angle greater than 90° means that the product moves against the net flow direction in that partial region.

In many cases, a fluid bed is fitted with a vibrating mechanism. Such a vibrating mechanism improves the homogeneity of the fluidization. The vibrating frequency is, for example, between 4 and 20 Hz, the latter not being limiting, of course. Often, this is referred to as a shaking bed (low frequencies) or vibrating bed (high frequencies).

With a fluid bed, the pressure drop and the air permeability of the screening sheet are important. Advantageously, the holes are as smooth as possible on the inside, which is better for the gas flow and cleaning.

Advantageously, the fluidizing base contains as many holes as possible. This offers the advantage that the gas flow and thus the treatment of the product as well, can be as homogeneous as possible. On the other hand, large holes offer the advantage of being easier to clean. It has been found that a number of between 10 000 and 40 000 holes per square meter with a diameter of the holes of between 0.2 and 0.9 mm produces an excellent, homogeneous fluidization result at a suitable pressure drop, all this depending on the diameter of the holes. The cleanability of the holes nevertheless remains good with the chosen method of producing holes. The number of holes is in this case calculated over the entire fluidizing base, that is to say including any areas without holes.

It is also possible to give the gas a desired direction, and thus also to give it the function of conveying product particles. To this end, the holes can be given a specific orientation, for example an angle between 15 and 50 degrees to a surface of the sheet. An angle of between 30 and 45 degrees to the surface of the sheet was found to provide a good optimum between orientation, product particle drop and gas flow.

Of course, it is also possible to give the holes in the fluidizing base, or in an adjoining part thereof, different orientations. This may offer the following advantages in what is known as a well-mixed bed, for example.

Higher drying capacity on the fluidizing base as a result of the high air load and high temperature, resulting in up to 15% increase in capacity.

More compact installation.

Improved powder properties.

Better control as a result of a buffer of powder which has already been dried as a thick layer of the fluidized bed.

More stable procedure which is less susceptible to failures.

Using the chosen technique to produce holes, it is possible to provide a fluidizing base with a desired multidirectional pattern of holes in a simple manner, and thereby also with a desired multidirectional flow of gas and product over the fluidizing base. By programming the laser beam source, it is in principle possible to provide each individual hole with a desired direction. With the known mechanical methods of producing holes, it is only possible to use one type of roller, which can cut or press holes in the sheet in only one direction. In order to provide the fluidizing base with several directions, differently oriented parts have to be welded together, which is laborious and can lead to holes being welded up. In general, it is very disadvantageous to weld in areas containing holes. Especially holes which have been half welded up or welded up on one side form a sanitary problem, since product may remain behind in these.

Another advantage of the method using a laser beam, or optionally an electron beam, to “shoot”, is that areas of the sheet can also be given a different density of holes or can even be kept free from holes. This offers further advantages for controlling the flow of gas or product, but is also advantageous for supporting the sheet in a fluidizing device. In many cases, such sheets are supported along their length and/or width by supports, strips or the like, to which the fluidizing base is often welded. If the fluidizing base has no holes at the position of the cross-beam or the like, it is not possible for any holes to be welded up or such like either. Using the method according to the invention, a fluidizing base in one piece can easily be provided with such a pattern.

It is also possible to provide an area without holes on the edge, even on the edge of a complex, i.e. not rectangular, fluidizing base or part thereof. By way of example, consideration may be given in this case to a segment or “wedge”. Due to the edge regions being free from holes, such sheets can still be connected in a simple manner, for example by means of welding, without holes being partially cut or welded up. Since no irregularities of this type occur in the sheet during connection, it is also possible to produce very complex, for example three-dimensional shapes, or areas of different materials, etcetera.

The angle of the holes is advantageously selected to be at least as large as the angle of repose of the product to be treated. The angle of repose of the product to be treated depends on the flow properties of the product, in particular the way it falls through the holes. An amount of product which has flowed out under normal circumstances forms a cone with a specific vertex angle, also referred to as angle of repose. If this product is situated on a sheet with a hole which is larger that the particle size of the product, but at an angle to this sheet which is equal to or larger than the angle of repose, the product will not flow freely through the hole, but will only drop into the hole to a minimal degree as a result of bridging. Thus, even with a flat sheet having holes which are larger than the product particles, it is possible to work with a very minimal drop. A good empirical value for the angle of the axis of the holes to the sheet is between 20 and 45 degrees, with holes of between 0.2 and 0.9 mm and product particle sizes of between 0.05 and 0.5 mm.

Preferably, the thickness of the sheet is such that it is not possible to look through the holes when looking at the sheet at right angles. This ensures that a reliable orientation can be given to the gas. The thickness of the sheet thus depends on the diameter of the holes and the angle between the holes and the sheet. For example, at an angle of 30 degrees and a diameter of the holes of approximately 0.8 mm, a sheet thickness of 2 mm is useful, although sheet thicknesses of between approximately 0.5 mm and 3 mm can also be useful. Incidentally, in practice, the sheet thickness is often chosen on the basis of additional criteria. Thus, a sheet which can be walked on is expedient for maintenance and a thickness of approximately 2 mm will be suitable.

The fluidizing air flows through the screening sheet at a certain pressure drop, such that a good distribution across the powder layer is ensured. According to a known, non-limiting rule the ratio of dP (sheet):dP (powder layer)=1:3 to 1:4, with an exemplary value of approx. 500 Pa for the sheet.

The invention will be explained in more detail below, with reference to the drawing, in which:

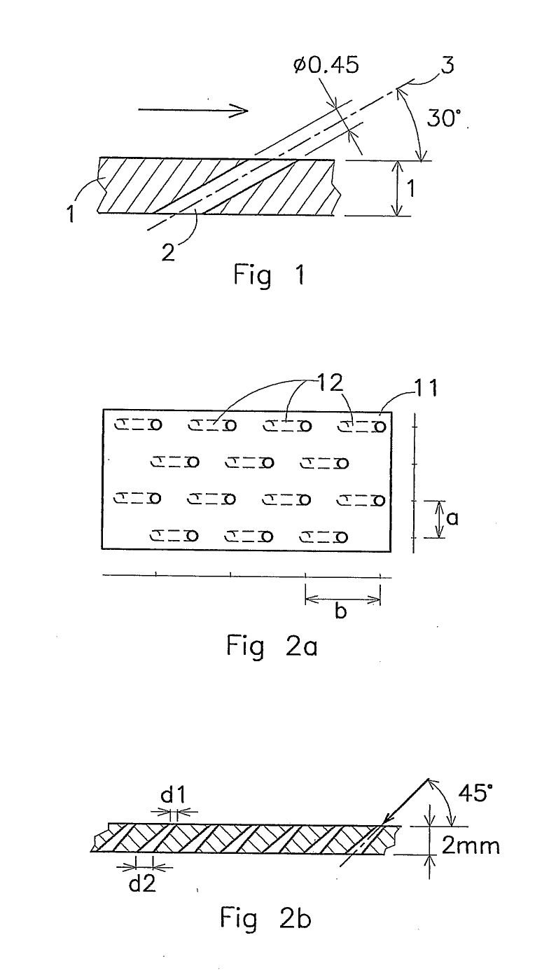

FIG. 1 shows a section through a fluidizing base according to the invention;

FIGS. 2a, b show a top and sectional view of another embodiment of a fluidizing base according to the invention;

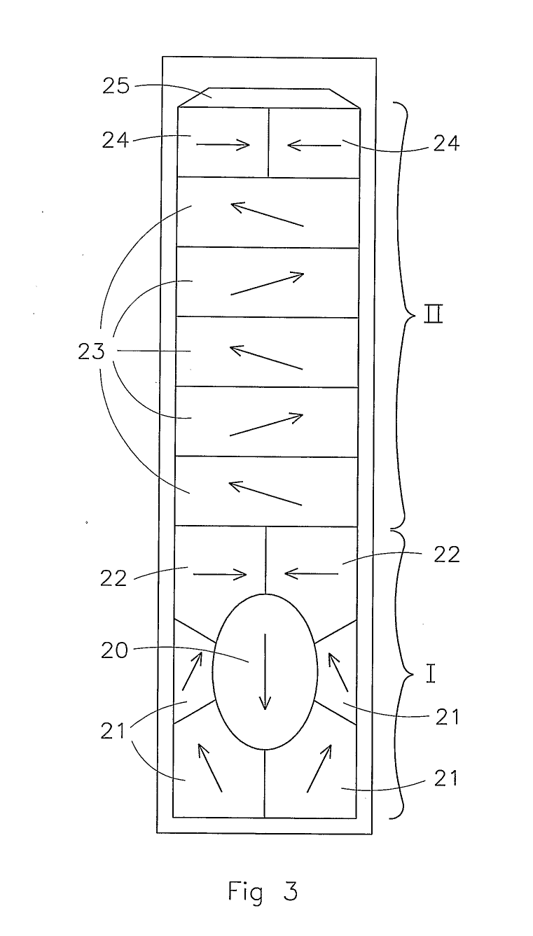

FIG. 3 shows an illustrative orientation pattern of the holes and thus of the gas flow in a fluidizing base according to the invention.

FIG. 1 shows a sheet 1 with a hole 2. The hole has an axis which is at an angle of approximately 30 degrees to the sheet. The thickness of a sheet is approximately 1 mm, and the hole has a diameter of approximately 0.45 mm. When viewing the sheet perpendicularly from above, it is not possible to see through it via this hole. The incline of the axis 3 of the hole gives a flow of gas flowing through the hole a desired orientation. Of course, the dimensions given for the thickness, angle and diameter of the hole are only given by way of example.

The direction of the axis 3 of the hole corresponds to that of the electron beam or laser beam. The angle may be chosen virtually as desired, but preferably not too small in order to prevent unnecessarily long ducts and the associated disadvantages. The diameter of the hole may be chosen within a relatively wide range as well and may vary, for example, from a few tenths of millimeters to 1 millimeter.

After one or more holes 2 have been made in the sheet 1 using an electron beam or laser beam 3, the sheet 1 can at least partially and in particular completely be finished. This finishing may serve, for example, to improve the internal quality of the holes 2. The finishing may in that case, for example, comprise electropolishing or chemical polishing of the holes 2. It is also possible for the sheet 1 to be rolled or the like, for example in order to impart a specific shape thereto. It should be noted that little, if any, rolling is required to repair the warping of the sheet 1 resulting from making the holes 2, as this, in contrast to the prior art, barely occurs, if at all. The latter is particularly true for laser drilling. In cases where, for example, drilling takes place in a vacuum chamber using an electron beam, this can be carried out by forming the sheet into a cylinder and then unrolling, which could cause some degree of warping.

FIGS. 2a and 2b show a partially cut-away top and sectional view, respectively, of another fluidizing sheet according to the invention with a pattern of holes 12 in a sheet 11. The holes have a diameter of d1 mm on one side of the sheet and a diameter of d2 mm on the opposite side. As a result of the increasing diameter, for example as a consequence of the laser beam, certain flow characteristics can be imparted to the gas. The angle of the axis of the holes to the sheet 11 is approximately 45 degrees. The density of holes is inversely proportional to the distances a and b, and may, for example, be approximately 100,000 per square meter. However, lower numbers of 10,000 to 40,000 per square meter also work sufficiently well. Often, the distances a and b each have a value of between 1 and 10 mm, although they are not limited thereto. The sheet thickness in this case is 2 mm, and it is not possible to see through the holes when viewing the sheet perpendicularly from above.

FIG. 3 shows an illustrative pattern of mean orientations of the holes in a fluidizing base according to the invention. In this case, I denotes what is known as a well-mixed area, with a quick mixing and drying action but a less well-defined residence time, and II denotes a plug-flow area with well-defined residence time and drying action.

Area I comprises a central area 20 having a first gas outflow direction, in this case directed away from area II, in order to make the residence time as long as possible. Furthermore, there are four areas 21 here, having respective outflow directions which convey product falling onto them to a point between the two areas 22. Here, product accumulates and flows to area II, the plug-flow area.

The plug-flow area in this case comprises five partial regions 23, each having its own outflow direction, as well as two discharge regions 24 and a product discharge 25.

Here, the partial regions 23 have a kind of zigzag-shaped outflow direction, the orientation of which may, however, also be different. The discharge regions 24 have the same function as the areas 22 at II, and force product to the discharge 25.

By giving the holes in various areas of the base a different orientation, the product particles can be given different flow directions as well, so that the treating gas flow can carry out its treatment to optimum effect. The one desired orientation may be opposite to that of an adjoining area of the base, or, for example, at a different angle thereto. It is also possible for the angle of a first group of holes to be different, for example to be smaller or larger, or equal, but with a different direction, to that of a second group of holes, so that the gas outflow speed relative to the fluidizing base is different, etc. It is also possible for the holes within one area to have different orientations, for example ⅔ to the left, ⅓ to the right, etc., which may result in improved fluidization, for example.

Particularly advantageously, substantially all holes are provided in one monolithic sheet, which means that the fluidizing base with the holes is not made up of a number of interconnected sheet parts, but that the sheet forms one single unit, without weld seams or the like. The method according to the invention in particular provides the opportunity to produce such a sheet with well-defined holes in a desired pattern, with partial regions and the like.

Obviously, the sheet may comprise components without holes, which can then be fitted to the sheet by welding or the like, or the sheet may be composed of various parts welded together, provided these parts have no holes on the edge to be welded, so that the latter cannot be half welded up, thus making them difficult to clean.

One practical example (not shown) of a fluidizing device according to the invention comprises, for example, a fluidizing base according to the invention with a width of approximately 0.3 to 2.5 meters and a length of, for example, between 4 and 16 meters, although in principle, it is possible, of course, to choose any other dimension. Furthermore, the device may comprise one or more of the following components:

product supply flange, product drain, gas supply plenum(s), gas supply lines, gas discharge lines, rotatable thresholds, fines return connections, hatches, viewing windows, vibrating mechanism for the base, sampling hatches, inspection lids, drive for, for example, the vibrating mechanism, gas supply and discharge ventilators, cyclone, gas treatment unit for cooling, conditioning or heating gas.
The fluidizing device can be used, for example, as powder discharge in a cloth filter installation, as conveying device in powder silos or more generally for treating powder.

1. Fluidizing base, comprising a smooth and even sheet having a large number of through-holes produced by means of a laser or electron beam and having a cross section with a ratio of length to width of at most 2:1.

2. Fluidizing base according to claim 1, in which at least part of the holes are at an acute angle to the sheet surface.

3. Fluidizing base according to claim 1, in which the acute angle is between 20 and 50 degrees, preferably between 30 and 45 degrees.

4. Fluidizing base according to claim 1, in which a plurality of first holes are at a first angle to the sheet surface, a plurality of second holes are at a second angle to the sheet surface, and in which the first and second holes between themselves enclose an angle of more than 0°.

5. Fluidizing base according to claim 4, in which the first holes are arranged in a first group having a substantially parallel first outflow direction, and the second holes in a second group having a substantially parallel second outflow direction, different from the first outflow direction.

6. Fluidizing base according to claim 5, in which the first and second group each form a continuous, non-overlapping group.

7. Fluidizing base according to claim 5, in which the holes of the first and the holes of the second group alternate in a regular pattern.

8. Fluidizing base according to claim 7, in which the pattern is formed by strips which extend in the width direction of the fluidizing base and have, viewed in the longitudinal direction of the fluidizing base, a width of in each case not more than ten holes, advantageously not more than five holes.

9. Fluidizing base according to claim 1, having a central region with holes in a first direction, with several peripheral regions around it with holes having a respective direction such that product landing on it is conveyed to an end point situated on one of the peripheral regions.

10. Fluidizing base according to claim 1, in which substantially all holes are provided in one monolithic sheet.

11. Fluidizing base according to claim 1, in which the number of holes is between 10,000 and 40,000 holes per square meter, calculated over the entire fluidizing base.

12. Fluidizing base according to claim 1, in which an area of the sheet is substantially free from holes over a width of at least 1.5 cm, holes having however been provided in the sheet on at least two opposite sides of that area.

13. Fluidizing base, comprising a plurality of fluidizing bases according to claim 1, in which these are connected up, preferably welded together, to a respective part which is free from holes.

14. Fluidizing base according to claim 1, in which the diameter of the holes is substantially between 0.2 and 1.0 mm, the sheet thickness being between 0.5 and 3 mm.

15. Fluidizing base according to claim 14, in which the ratio of the diameter of the holes and sheet thickness is between 1:10 and 1:2.

16. Method for producing a fluidizing base according to claim 1, comprising the steps of:
providing a smooth and even sheet made of a metal alloy,
providing a plurality of through-holes in the sheet by means of a laser or electron beam,
the holes having a diameter with a length-to-width ratio of not more than 2:1.

17. Method according to claim 16, in which the sheet essentially does not move relative to the laser or electron beam while a hole is being produced.

18. Method according to claim 16, in which the laser or electron beam for different holes in the sheet is directed at the sheet at different angles.

19. Method according to claim 16, in which at least a part of the sheet undergoes a finishing operation.

20. Method according to claim 19, in which the finishing operation comprises electropolishing, chemical polishing or rolling.

21. Fluidizing base which is produceable according to claim 16.

22. Fluidizing device comprising at least a fluidizing base according to claim 1 and a gas supply which is connected to the fluidizing base.

23. Fluidizing device according to claim 22, in which the fluidizing base comprises several areas with different gas outflow directions.

24. Fluidizing device according to claim 23, in which the fluidizing base comprises a first, substantially round area having gas outflow directions in essentially the circumferential direction, as well as an adjoining elongate area having a net gas outflow direction in the longitudinal direction of this elongate area.

25. Fluidizing device according to claim 24, in which the elongate area comprises several partial regions having a gas outflow direction which is at an angle not equal to zero to the net gas outflow direction.

26. Fluidizing device according to claim 22, further comprising a vibrating mechanism in order to make at least one area of the fluidizing device, in particular the fluidizing base, vibrate.
